(19) United States
(12) Patent Application Publication
(10) Pub. No.: US 2022/0276705 A1
(43) Pub. Date: Sep. 1, 2022

(54) INFORMATION PROCESSING METHOD, INFORMATION PROCESSING DEVICE, AND NON-TRANSITORY COMPUTER READABLE STORAGE MEDIUM

(71) Applicants: Swallow Incubate Co., Ltd., Ibaraki (JP); Panasonic Holdings Corporation, Osaka (JP)

(72) Inventor: Toshikazu OHNO, Ibaraki (JP)

(21) Appl. No.: 17/746,305

(22) Filed: May 17, 2022

Related U.S. Application Data
(63) Continuation of application No. PCT/JP2020/004558, filed on Feb. 6, 2020.

(30) Foreign Application Priority Data
Nov. 21, 2019 (JP) 2019-210364

(51) Int. Cl. G06F 3/01; G06F 21/32; G06V 40/18; G06V 40/16

(52) U.S. Cl. CPC G06F 3/013; G06F 21/32; G06V 40/197; G06V 40/161; G06V 40/168

(57) ABSTRACT

An information processing method includes: for each of one or more users, acquiring image data including an eye of each of the users; detecting eye gaze information indicating an eye gaze of each of the users based on information indicating the eye of each of the users included in the image data; performing personal authentication on each of the users based on information indicating the eye of each of the users included in the image data; acquiring personal information for identifying each of the users for which the personal authentication has been performed; generating management information in which the personal information of the one or more users and the eye gaze information of the one or more users are associated with each other; and outputting the management information.

### TECHNICAL FIELD

The present disclosure relates to a technique of generating information in which personal information of a user and information indicating an eye gaze of the user are associated.

### BACKGROUND ART

The eye gaze detection technique is used in various applications such as estimation of a person's interest target, estimation of a person's state such as drowsiness, and a user interface that performs input to equipment by an eye gaze. When estimating the state and behavior of a person based on eye gaze information, it is useful to use information in which the eye gaze information and information regarding the person are associated with each other. As such an example, Patent Literature 1 discloses a technique of using, when estimating a behavior of a customer in a store, information in which eye gaze information of the customer in the store is associated with attribute information of the customer such as age and gender and information (Point Of Sales (POS) information) regarding a product purchased by the customer.

However, in the technique disclosed in Patent Literature 1, the equipment becomes large in scale, and it is difficult to accurately associate eye gaze information with information regarding the person, and hence further improvement is necessary.

### CITATION LIST

### Patent Literature

Patent Literature 1: JP 2017-102564 A

### SUMMARY OF INVENTION

The present disclosure has been made to solve such a problem, and an object is to accurately generate, with a simpler configuration, information in which eye gaze information and information regarding a person are associated with each other.

One aspect of the present disclosure is an information processing method in an information processing device, the information processing method including: for each of one or more users, acquiring image data including an eye of each of the users; detecting eye gaze information indicating an eye gaze of each of the users based on information indicating the eye of each of the users included in the image data; performing personal authentication on each of the users based on information indicating the eye of each of the users included in the image data; acquiring personal information for identifying each of the users for which the personal authentication has been performed; generating management information in which the personal information of the one or more users and the eye gaze information of the one or more users are associated with each other; and outputting the management information.

### BRIEF DESCRIPTION OF DRAWINGS

FIG. 1 is a view showing an example of an overall configuration of an image processing system according to a first embodiment of the present disclosure.

FIG. 2 is a block diagram showing an example of a detailed configuration of the image processing system according to the first embodiment.

FIG. 3 is a view showing an example of an eye region.

FIG. 4 is a view showing an example of an authentication information table.

FIG. 5 is a view showing an example of a user information table.

FIG. 6 is a flowchart showing an example of an operation of an image processing device according to the first embodiment.

FIG. 7 is a view showing an example of a management information table.

FIG. 8 is a view showing another example of a management information table.

FIG. 9 is a flowchart showing an example of an operation of an image processing device according to a fifth embodiment.

FIG. 10 is a flowchart showing an example of the operation of the image processing device according to the fifth embodiment.

FIG. 11 is a view showing an example of a temporary management information table.

FIG. 12 is a block diagram showing an example of a detailed configuration of the image processing system according to a sixth embodiment.

### DESCRIPTION OF EMBODIMENTS

### Findings Underlying Present Disclosure

In the technique disclosed in Patent Literature 1 described above, in order to generate a heat map indicative of an attention degree of the purchaser relative to a product, a store is divided into a plurality of areas, and information in which an attribute of the customer is associated with a movement line (stopped-by area or the like) of the customer, information in which a product arranged in each area is associated with a position to which an eye gaze of the customer is oriented, and the like are used. Wireless sensor cameras installed on a ceiling and a wall surface of a store are used in order to acquire information regarding attributes and movement lines of customers. An eye gaze sensor attached to a product display shelf is used in order to acquire information indicating an eye gaze of a customer.

Therefore, the technique disclosed in Patent Literature 1 has a problem that in order to generate information in which eye gaze information of a customer and behavior information of the customer are associated with each other, equipment used for acquiring the eye gaze information of the customer and the behavior information of the customer becomes large in scale. In the technique disclosed in Patent Literature 1, pieces of information acquired at different timings in a plurality of pieces of equipment are combined stepwise to obtain information in which eye gaze information and behavior information are associated with each other. For this reason, the processing of combining the information becomes complicated, resulting in a problem that the accuracy of the temporal correspondence relationship between the eye gaze information and the behavior information may decrease.

Therefore, as a result of conducting detailed studies on such a problem, the present inventor has obtained a finding that information in which eye gaze information and information regarding a person are associated with each other can be accurately generated with a simpler configuration by using an image including an eye of the user not only for detection of the eye gaze information but also for personal authentication, and the present inventor has conceived of the following aspects.

An information processing method according to one aspect of the present disclosure is an information processing method in an information processing device, the information processing method including: for each of one or more users, acquiring image data including an eye of each of the users; detecting eye gaze information indicating an eye gaze of each of the users based on information indicating the eye of each of the users included in the image data; performing personal authentication on each of the users based on information indicating the eye of each of the users included in the image data; acquiring personal information for identifying each of the users for which the personal authentication has been performed; generating management information in which the personal information of the one or more users and the eye gaze information of the one or more users are associated with each other; and outputting the management information.

In the present configuration, for each of one or more users, based on information indicating an eye of each user included in image data including the eye of each user, detection of eye gaze information and personal authentication are performed, and the personal information of each user is acquired. Then, the present configuration generates and outputs management information in which the personal information of one or more users thus acquired and the eye gaze information of one or more users are associated with each other.

Therefore, with the present configuration, the image data used for generating the management information in which the eye gaze information and the personal information of each user are associated with each other can be limited only to the image data including the eye of each user. As a result, with the present configuration, the information in which the eye gaze information of each user is associated with the personal information of each user can be generated with a simpler configuration.

Furthermore, in the present configuration, the eye gaze information of each user and the image data used for personal authentication are the same, it is possible to detect the eye gaze information and perform the personal authentication, based on the information indicating the eye of each user at the same time point. This makes it possible to acquire the eye gaze information and the personal information having no temporal difference with respect to the user who has been subjected to the personal authentication, and to generate information in which the eye gaze information and the personal information are associated with each other. Therefore, based on the information indicating the eye of each user at different time points from each other, the present configuration can generate information in which the eye gaze information and the personal information of each user are associated with each other with higher accuracy than in a case where the detection of the eye gaze information and the personal authentication are performed.

In the above aspect, the personal information may include one or more attributes indicating a nature or a feature of each of the users. In output of the management information, based on the management information, eye gaze usage information in which the eye gaze information is classified for each of the one or more attributes may be further generated, and the eye gaze usage information may be output.

According to the present configuration, further, the eye gaze usage information in which the eye gaze information is classified for each of one or more attributes based on the management information is generated and output. Therefore, the viewer of the eye gaze usage information having been output can easily grasp the tendency of the eye gaze of the user having the same one or more attributes.

In the above aspect, the one or more attributes may include one or more of an age, a gender, a work place, and a job type.

According to the present configuration, the eye gaze usage information in which the eye gaze information is classified by one or more of the age, the gender, the work place, and the job type is generated and output. Therefore, the viewer of the eye gaze usage information having been output can easily grasp the tendency of the eye gaze of the user having the same one or more attributes of the age, the gender, the work place, and the job type.

In the above aspect, the eye gaze information may include eye gaze position information indicating a position to which an eye gaze of each of the users is oriented, and the eye gaze usage information may be a heat map representing a relationship between a position indicated by the eye gaze position information and a frequency at which the eye gaze of the user is oriented to a position indicated by the eye gaze position information.

According to the present configuration, the heat map representing the relationship between the position indicated by the eye gaze position information and the frequency at which the eye gaze of the user is oriented to the position indicated by the eye gaze position information is output as the eye gaze usage information. Therefore, the viewer of the heat map having been output can easily grasp which position the eye gaze of the user having the same attribute is frequently oriented to.

In the above aspect, the eye gaze information may include eye gaze position information indicating a position to which the eye gaze of each of the users is oriented, and the eye gaze usage information may be a gaze plot representing a relationship among the position indicated by the eye gaze position information, a number of times the eye gaze of the user is oriented to the position indicated by the eye gaze position information, and a movement route of the eye gaze of the user to the position indicated by the eye gaze position information.

According to the present configuration, the gaze plot representing the relationship among the position indicated by the eye gaze position information, the number of times the eye gaze of the user is oriented to the position indicated by the eye gaze position information, and the movement route of the eye gaze of the user to the position indicated by the eye gaze position information is output as the eye gaze usage information. Therefore, the viewer of the gaze plot having been output can easily grasp which position on which movement route the eye gaze of the user having the same attribute is oriented to many times.

In the above aspect, in detection of the eye gaze information, information indicating the eye of each of the users and information indicating the orientation of the face of each of the users may be detected from the image data, and the eye gaze information may be detected based on the detected information indicating the eye of each of the users and the detected information indicating the orientation of the face of each of the users.

According to the present configuration, the information indicating the eye of each user and the information indicating the orientation of the face of each user are detected from the image data including the eye of each user, and the eye gaze information is detected based on the detected information. Thus, the present configuration can accurately detect the eye gaze of each user from the information indicating the eye and the orientation of the face obtained from the image data.

In the above aspect, in personal authentication of each of the users, iris information indicating an iris of the eye of each of the users may be detected from the image data, and each of the users may be subjected to the personal authentication based on the detected iris information.

According to the present configuration, the iris information indicating the iris of the eye of each user is detected from the image data including the eye of each user, and each user is subjected to the personal authentication based on the detected iris information. Thus, in the present configuration, it is possible to accurately perform personal authentication of each user based on the iris unique to each user.

In the above aspect, the one or more users may be participants in an exhibition, the one or more attributes may include a work place of the participants, the eye gaze information may include exhibit information indicating an exhibit of the exhibition existing at a position to which an eye gaze of each of the users is oriented, and the eye gaze usage information may be a heat map representing a relationship between an exhibit of the exhibition indicated by the exhibit information and a frequency at which the eye gaze of the user is oriented to the exhibit of the exhibition.

In the present configuration, one or more users are participants of an exhibition, and the attribute of each user includes the work place of the participant. In addition, a heat map representing the relationship between an exhibit of the exhibition indicated by the exhibit information and the frequency at which the eye gaze of the user is oriented to the exhibit of the exhibition is output as the eye gaze usage information. For this reason, the viewer of the heat map having been output can easily grasp, for example, in the exhibition, an eye gaze of a participant of which work place is highly frequently oriented to which exhibit.

In the above aspect, the one or more users may be workers at a manufacturing site, the one or more attributes may include work proficiency of the workers, the eye gaze information may include work target information indicating a work target present at a position to which an eye gaze of each of the users is oriented, and the eye gaze usage information may be a heat map representing a relationship between the work target indicated by the work target information and a frequency at which the eye gaze of the user is oriented to the work target.

In the present configuration, the one or more users are workers at a manufacturing site, and the attribute of each user includes the work proficiency of the worker. Furthermore, a heat map representing a relationship between the work target indicated by the work target information and the frequency at which the eye gaze of the user is oriented to the work target is output as the eye gaze usage information. Therefore, the viewer of the heat map having been output can easily grasp, for example, at the manufacturing site, which work target an eye gaze of a highly proficient worker is frequently oriented to.

In the above aspect, the image data may be captured by an infrared light camera.

In the image data captured by the infrared light camera, luminance change of the outer edge of each of the pupil and the iris tends to appear clearly. Furthermore, in the present configuration, each user is subjected to personal authentication based on information indicating the eye of each user included in the image data captured by the infrared light camera. Therefore, according to the present configuration, the iris information indicating the iris of the eye of each user can be accurately detected from the image data as the information indicating the eye of each user used for personal authentication. As a result, it is possible for the present configuration to accurately perform personal authentication of each user.

The present disclosure can also be implemented as a control program for causing a computer to execute each characteristic configuration included in such an information processing method, or an information processing device operated by this control program. Furthermore, it goes without saying that such a control program can be distributed via a computer-readable non-transitory recording medium such as a CD-ROM or a communication network such as the internet.

Note that each of the embodiments described below shows a specific example of the present disclosure. Numerical values, shapes, constituent elements, steps, orders of steps, and the like shown in the following embodiments are merely examples, and are not intended to limit the present disclosure. Among the constituent elements in the following embodiments, constituent elements that are not described in independent claims indicating the highest concept are described as discretionary constituent elements. In addition, in all the embodiments, each of the contents can be combined.

### First Embodiment

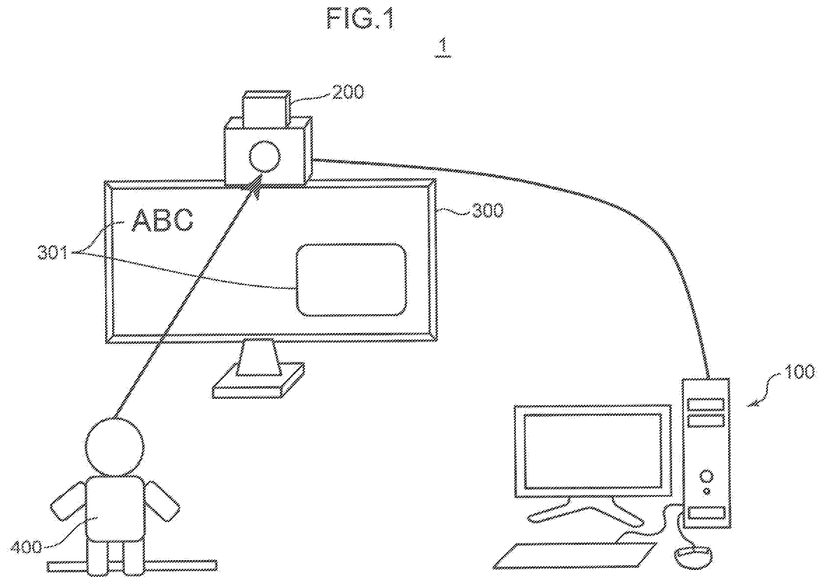

FIG. 1 is a view showing an example of an overall configuration of an image processing system 1 according to the first embodiment of the present disclosure. The image processing system 1 is a system that captures a person 400 and detects eye gaze information indicating an eye gaze of the person 400 from the obtained image data of the person 400. In the example of FIG. 1, the image processing system 1 specifies which object 301 the person 400 gazes at among a plurality of objects 301 displayed on a display device 300. However, this is an example, and the image processing system 1 may specify not only the object 301 displayed on the display screen of the display device 300 but also the object 301 gazed by the person 400 in the real space.

In the example of FIG. 1, the image processing system 1 is applied to a digital signage system. Therefore, the object 301 displayed on the display device 300 is an image of signage such as an advertisement. Furthermore, the image processing system 1 generates and outputs information, obtained based on the image data of the person 400, in which information indicating the eye gaze of the person 400 is associated with the personal information of the person 400.

The image processing system 1 includes an image processing device 100 (an example of an information processing device), a camera 200, and a display device 300. The image processing device 100 is connected to the camera 200 and the display device 300 via a predetermined communication path. The predetermined communication path is, for example, a wired communication path such as a wired LAN, or a wireless communication path such as a wireless LAN and Bluetooth (registered trademark). The image processing device 100 includes, for example, a computer installed around the display device 300. However, this is an example, and the image processing device 100 may include a cloud server. In this case, the image processing device 100 is connected to the camera 200 and the display device 300 via the Internet. The image processing device 100 detects eye gaze information of the person 400 from the image data of the person 400 captured by the camera 200, and outputs the eye gaze information to the display device 300. Furthermore, the image processing device 100 may be incorporated as hardware in the camera 200 or the display device 300. Furthermore, the camera 200 or the display device 300 may include a processor, and the image processing device 100 may be incorporated as software.

By capturing an image of an environment around the display device 300 at a predetermined frame rate, for example, the camera 200 acquires image data of the person 400 positioned around the display device 300. The camera 200 sequentially outputs the acquired image data to the image processing device 100 at a predetermined frame rate. The camera 200 may be a visible light camera or may be an infrared light camera.

The display device 300 includes a display device such as a liquid crystal panel or an organic EL panel. In the example of FIG. 1, the display device 300 is a signage display. Note that in the example of FIG. 1, the image processing system 1 is described to include the display device 300, but this is an example, and another piece of equipment may be adopted instead of the display device 300. For example, if the image processing system 1 is used as a user interface that receives an input to equipment by an eye gaze, the image processing system 1 may adopt home appliances such as a refrigerator, a television set, and a washing machine instead of the display device 300, for example. For example, if the image processing system 1 is mounted on a vehicle, a vehicle such as an automobile may be adopted instead of the display device 300. Furthermore, a storage device such as a hard disk drive or a solid state drive may be adopted instead of the display device 300.

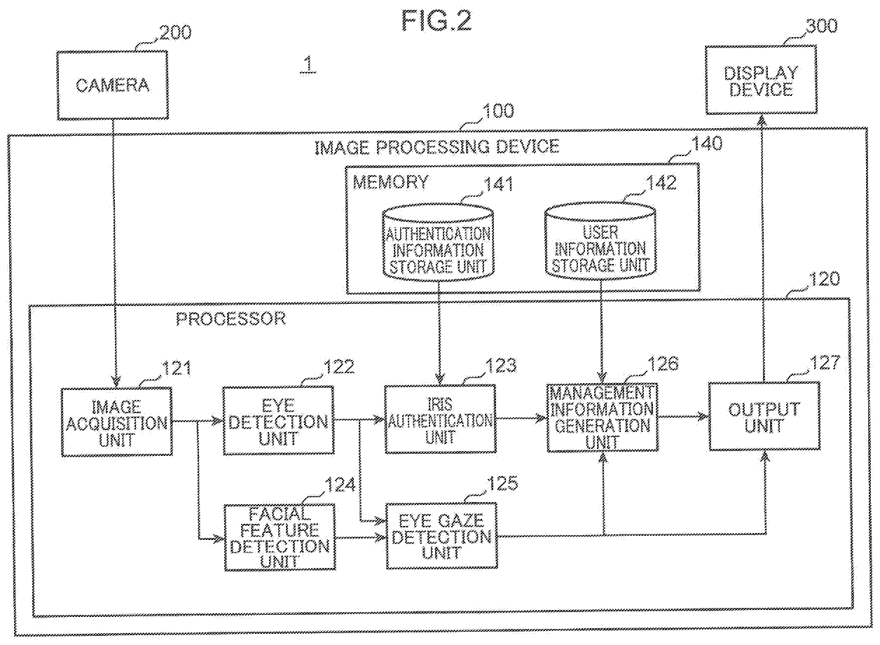

FIG. 2 is a block diagram showing an example of a detailed configuration of the image processing system 1 according to the first embodiment. The image processing device 100 includes a processor 120 and a memory 140.

The processor 120 is an electric circuit such as a CPU or an FPGA. The processor 120 includes an image acquisition unit 121, an eye detection unit 122, an iris authentication unit 123 (an example of the authentication unit), a facial feature detection unit 124, an eye gaze detection unit 125, a management information generation unit 126 (a part of the personal information acquisition unit), and an output unit 127. Note that each block included in the processor 120 may be implemented by the processor 120 executing a control program for causing a computer to function as an image processing device, or may be configured by a dedicated electric circuit.

The image acquisition unit 121 acquires image data captured by the camera 200. Here, the acquired image data includes the face of the person 400 (an example of the user) around the display device 300. Note that the image data acquired by the image acquisition unit 121 may be, for example, image data posted on a website or may be image data stored in an external storage device.

The eye detection unit 122 detects an eye region including the eye of the person 400 from the image data acquired by the image acquisition unit 121. Specifically, the eye detection unit 122 is only required to detect the eye region using a classifier created in advance for detecting the eye region. The classifier used here is a Haar-like cascade classifier created in advance for detecting the eye region in an open-source image processing library, for example.

The eye region is a rectangular region having a size in which a predetermined margin is added to the size of the eye. However, this is an example, and the shape of the eye region may be, for example, a triangle, a pentagon, a hexagon, an octagon, or the like other than a rectangle. Note that the position at which the boundary of the eye region is set with respect to the eye depends on the performance of the classifier.

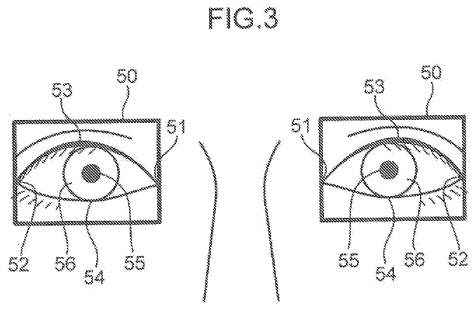

FIG. 3 is a view showing an example of an eye region 50. In the present embodiment, the eye refers to a region including the white of the eye and a colored part such as the iris that are surrounded by a boundary 53 of the upper eyelid and a boundary 54 of the lower eyelid as shown in FIG. 3. As shown in FIG. 3, the colored part includes a pupil 55 and a donut-like iris 56 surrounding the pupil 55. In the present embodiment, for convenience of description, the right eye refers to the eye on the right side when the person 400 is viewed from the front, and the left eye refers to the eye on the left side when the person 400 is viewed from the front. FIG. 3 shows an example in which the eye detection unit 122 detects the eye region 50 including the right eye and the eye region 50 including the left eye. However, this is an example, and the eye on the right side as viewed from the person 400 may be the right eye and the eye on the left side as viewed from the person 400 may be the left eye. In the present embodiment, the direction on the right side of the paper surface is defined as the right side, and the direction on the left side of the paper surface is defined as the left side.

The iris authentication unit 123 detects iris information indicating the iris 56 of the eye of the person 400 in the eye region 50 detected by the eye detection unit 122, and performs personal authentication of the person 400 using the detected iris information and an authentication information storage unit 141.

The iris information includes, for example, coordinate data indicating the outer edge of the iris 56 or information indicating a length (e.g., a pixel) such as a radius or a diameter of the outer edge of the iris 56, and coordinate data of the center of the iris 56. Here, the coordinate data refers to two-dimensional coordinate data in the image data acquired by the image acquisition unit 121. The iris information includes iris data obtained by coding an image of the iris 56 with a predetermined algorithm such as a Daugman algorithm, for example. Daugman algorithm is disclosed in the document “High Confidence Visual Recognition of Persons by a Test of Statistical Independence: John G. Daugman (1993)”. Note that the iris data is not limited thereto, and may be image data (binary data) in which an image of the iris 56 is represented in a predetermined file format (e.g., PNG).

If an infrared light camera is adopted as the camera 200, the luminance changes between the pupil 55 and the iris 56 appears clearly Therefore, if an infrared light camera is adopted as the camera 200, the iris authentication unit 123 may further detect, as the iris information, coordinate data indicating the outer edge of the pupil 55, for example, or information indicating a length (e.g., a pixel) such as a radius or a diameter of the outer edge of the pupil 55, and coordinate data of the center of the pupil 55. On the other hand, if a visible light camera is adopted as the camera 200, there is a case where a luminance change between the pupil 55 and the iris 56 does not appear clearly, and hence, it is difficult to distinguish between the pupil 55 and the iris 56. Therefore, if a visible light camera is adopted as the camera 200, the iris authentication unit 123 may not detect the coordinate data and information regarding the pupil 55 described above. Detail of the personal authentication of the person 400 using the iris information and the authentication information storage unit 141 will be described later.

The facial feature detection unit 124 detects a facial feature point of the person 400 from the image data acquired by the image acquisition unit 121. The facial feature point is one or a plurality of points at characteristic positions in each of a plurality of parts constituting the face such as the outer corner of the eye, the inner corner of the eye, the contour of the face, the ridge of the nose, the corner of the mouth, and the eyebrow, for example.

Specifically, the facial feature detection unit 124 first detects a face region indicating the face of the person 400 from the image data acquired by the image acquisition unit 121L For example, the facial feature detection unit 124 is only required to detect the face region using a classifier created in advance for detecting the face region. The classifier used here is a Haar-like cascade classifier created in advance for detecting the face region in an open-source image processing library, for example. The face region is a rectangular region having a size enough to include the entire face, for example. However, this is an example, and the shape of the face region may be, for example, a triangle, a pentagon, a hexagon, an octagon, or the like other than a rectangle. Note that the facial feature detection unit 124 may detect the face region by pattern matching.

Next, the facial feature detection unit 124 detects a facial feature point from the detected face region. The feature point is also called a landmark. The facial feature detection unit 124 is only required to detect a facial feature point by executing landmark detection processing using a model file of a framework of machine learning, for example.

The eye gaze detection unit 125 detects information indicating the eye gaze (hereinafter, eye gaze information) of the person 400 based on the facial feature point detected by the facial feature detection unit 124 and the information indicating the eye of the person 400 included in the eye region 50 detected by the eye detection unit 122.

Specifically, by performing known face orientation detection processing, the eye gaze detection unit 125 detects face orientation information indicating the orientation of the face of the person 400 from the arrangement pattern of the facial feature point detected by the facial feature detection unit 124. The face orientation information includes an angle indicating the front direction of the face with respect to the optical axis of the camera 200, for example.

Next, by performing known eye gaze detection processing for detecting an eye gaze by a three-dimensional eyeball model, the eye gaze detection unit 125 detects the eye gaze information based on the above-described detected face orientation information and the information indicating the eye of the person 400 included in the eye region 50 detected by the eye detection unit 122. The information indicating the eye includes, for example, the positions of the colored part, the inner corner of the eye, the outer corner of the eye, and the center of gravity of the eye. Furthermore, the information indicating the eye includes, for example, iris information detected from the eye region 50 by the iris authentication unit 123. The eye gaze information includes capturing date and time of the image data used to detect the eye gaze information and coordinate data of an eye gaze point on a predetermined target plane (e.g., the display device 300). The eye gaze point is a position to which the eye gaze of the person 400 is oriented, and is, for example, a position where a target plane and a vector indicating the eye gaze intersect. Note that the eye gaze information may include a vector indicating the direction of the eye gaze of the person 400 instead of the coordinate data of the eye gaze point or in addition to the coordinate data of the eye gaze point. The vector is only required to be expressed by, for example, an angle of a horizontal component with respect to a reference direction such as an optical axis direction of the camera 200 and an angle in a vertical direction with respect to the reference direction.

The management information generation unit 126 acquires, from a user information storage unit 142, personal information for identifying the user who has been subjected to the personal authentication each time the user of the image processing system 1 is captured by the camera 200 and the user is subjected to the personal authentication by the iris authentication unit 123. Furthermore, when the eye gaze detection unit 125 detects the eye gaze information from the image data obtained by capturing the user who has been subjected to the personal authentication, the management information generation unit 126 generates information (hereinafter, eye gaze management information) in which the detected eye gaze information is associated with the acquired personal information. Details of the acquisition of the personal information using the user information storage unit 142 and the generation of the eye gaze management information will be described later.

The output unit 127 outputs, to the display device 300, the eye gaze information detected by the eye gaze detection unit 125. The output unit 127 may acquire information of the object 301 displayed on the display device 300, specify the object 301 (hereinafter, gaze object) at which the person 400 gazes from the acquired information and the coordinate data of the eye gaze point, and output the specification result to the display device 300.

In addition, the output unit 127 stores (an example of outputting) the eye gaze management information for one or more users generated by the management information generation unit 126 in a memory (not illustrated) included in the processor 120 or a storage device (not illustrated) such as a hard disk drive or a solid state drive included in the image processing device 100. Note that the output unit 127 may output, to the display device 300, the eye gaze management information for one or more users generated by the management information generation unit 126.

The memory 140 is a storage device such as a hard disk drive or a solid state drive. The memory 140 includes the authentication information storage unit 141 and the user information storage unit 142.

The authentication information storage unit 141 stores an authentication information table in advance. The authentication information table is a table in which the iris authentication unit 123 stores authentication information used for personal authentication of the user of the image processing system 1.

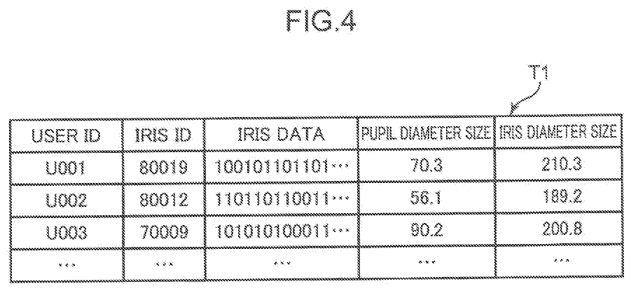

FIG. 4 is a view showing an example of an authentication information table T1. Specifically, as shown in FIG. 4, the authentication information stored in the authentication information table T1 includes “user ID”, “iris ID”, “iris data”, “pupil diameter size”, and “iris diameter size”. The “user ID” is an identifier uniquely allocated to the user of the image processing system 1. The “iris ID” is an identifier uniquely allocated to the “iris data”. The “iris data” is data obtained by coding an image of the iris 56 of the user of the image processing system 1 with a predetermined algorithm such as a Daugman algorithm.

The “pupil diameter size” is the diameter of an outer edge of the pupil 55 of the user of the image processing system 1. The “iris diameter size” is the diameter of an outer edge of the iris 56 of the user of the image processing system 1. Note that the authentication information table T1 is only required to store at least the “user ID”, the “iris ID”, and the “iris data”, and may not store one or more of the “pupil diameter size” and the “iris diameter size”.

The user information storage unit 142 stores a user information table in advance. The user information table is a table that stores personal information of the user of the image processing system 1.

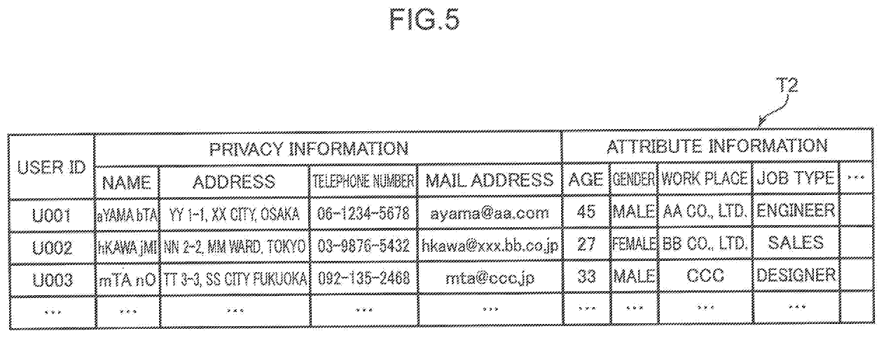

FIG. 5 is a view showing an example of a user information table T2. Specifically, as shown in FIG. 5, the personal information stored in the user information table T2 includes “user ID”, “privacy information”, and “attribute information”. The “user ID” is an identifier uniquely allocated to the user of the image processing system 1. The “privacy information” is information regarding privacy that can uniquely identify the user of the image processing system 1. In the example of FIG. 5, the “privacy information” includes “name”, “address”, “telephone number”, and “mail address”. The “name”, the “address”, the “telephone number”, and the “mail address” are a name, an address, a telephone number, and a mail address of the user of the image processing system 1, respectively. The “attribute information” is information indicating one or more attributes indicating the nature or feature of the user of the image processing system 1. In the example of FIG. 5, the “attribute information” includes “age”, “gender”, “work place”, and “job type”. The “age,” the “gender,” the “work place,” and the “job type” are the age, the gender, the work place, and the job type of the user of the image processing system 1, respectively. The “attribute information” is not limited thereto, and is only required to include one or more of “age”, “gender”, “work place”, and “job type”.

Since the camera 200 has been described with reference to FIG. 1, the description thereof is omitted here.

The display device 300 displays a marker indicating the eye gaze information output from the output unit 127. The display device 300 may display a marker indicating the object 301 gazed by the person 400 output from the output unit 127. For example, it is assumed that coordinate data of the eye gaze point is output to the display device 300 as eye gaze information. In this case, the display device 300 performs processing of displaying, at a position corresponding to the coordinate data, a marker indicating the eye gaze position superimposed on the screen being displayed. For example, it is assumed that a specification result of the eye gaze object is output to the display device 300. In this case, the display device 300 may perform processing of displaying a marker indicating the eye gaze object superimposed on the screen being displayed. Furthermore, the display device 300 may display the eye gaze management information regarding one or more users output from the output unit 127.

Note that, in a case where the image processing system 1 includes a home appliance instead of the display device 300, the home appliance receives an input of the person 400 from the eye gaze information. Furthermore, in a case where the image processing system 1 includes a storage device instead of the display device 300, the storage device stores the eye gaze information. In this case, the storage device may store the eye gaze information in association with a time stamp.

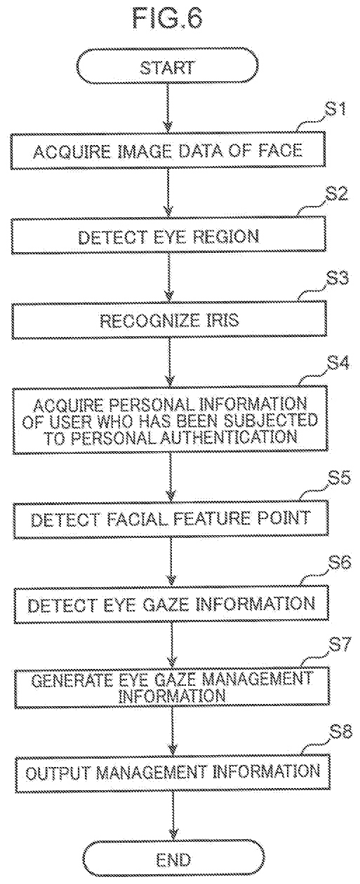

Next, the operation of the image processing device 100 will be described. FIG. 6 is a flowchart showing an example of the operation of the image processing device 100 according to the first embodiment. The operation of the image processing device 100 shown in FIG. 6 is started periodically (e.g., every second). When the operation of the image processing device 100 is started and the image acquisition unit 121 acquires image data of the face of the person 400 from the camera 200 (step S1), the eye detection unit 122 detects the eye region 50 from the image data by inputting the image data acquired in step S1 to a classifier for detecting the eye region 50 (step S2).

Next, the iris authentication unit 123 detects iris information indicating the iris 56 of the eye of the person 400 in the eye region 50 detected in step S2, and performs personal authentication of the person 400 using the detected iris information and the authentication information storage unit 141 (step S3).

Specifically, in step S3, the iris authentication unit 123 refers, record by record, to the authentication information table T1 (FIG. 4) stored in the authentication information storage unit 141. Next, the iris authentication unit 123 calculates a ratio (hereinafter, the first ratio) between the length of the diameter of the outer edge of the pupil 55 included in the detected iris information and the length of the diameter of the outer edge of the iris 56 included in the detected iris information. Furthermore, the iris authentication unit 123 calculates a ratio (hereinafter, the second ratio) between the “pupil diameter size” included in the referred record and the “iris diameter size” included in the referred record.

Then, the iris authentication unit 123 determines whether or not the difference between the first ratio and the second ratio is equal to or less than a predetermined first threshold value. When it is determined that the difference between the first ratio and the second ratio is equal to or less than the first threshold value, the iris authentication unit 123 determines whether or not the similarity between the iris data included in the detected iris information and the “iris data” of the referred record is equal to or greater than a predetermined second threshold value. When it is determined that the similarity is equal to or greater than the second threshold value, the iris authentication unit 123 performs personal authentication that the person 400 is a user of the image processing system 1 identified by the “user ID” included in the referred record. Then, as the user ID of the user who has been subjected to the personal authentication, the iris authentication unit 123 outputs the “user ID” of the referred record.

Next, the management information generation unit 126 acquires the personal information of the person 400 who has been subjected to the personal authentication in step S3 (step S4). Specifically, in step S4, in the user information table T2 (FIG. 5) stored in advance in the user information storage unit 142, the management information generation unit 126 acquires, as the personal information of the person 400, the record including the “user ID” matching the user ID of the user who has been subjected to the personal authentication, output by the iris authentication unit 123 in step S3. In the example of FIG. 5, when the user ID of the person 400 who has been subjected to the personal authentication is “U001”, the management information generation unit 126 acquires, as the personal information of the person 400, a record in a first line including the user ID “U001” which matches the user ID, the “privacy information” in which the “name” is “aYAMA bTA”, and the “attribute information” in which the “age” is “45”.

Next, the facial feature detection unit 124 detects a facial feature point of the person 400 from the image data acquired by the image acquisition unit 121 in step S1 (step S5). Next, the eye gaze detection unit 125 detects eye gaze information based on the facial feature point detected in step S5 and the information indicating the eye of the person 400 included in the eye region 50 detected in step S2 (step S6).

Specifically, in step S6, the eye gaze detection unit 125 detects face orientation information indicating the orientation of the face of the person 400 from the arrangement pattern of the facial feature point detected by the facial feature detection unit 124 performing known face orientation detection processing in step S5. Next, by performing known eye gaze detection processing for detecting an eye gaze by a three-dimensional eyeball model, the eye gaze detection unit 125 detects the eye gaze information based on the detected face orientation information and the information indicating the eye of the person 400 included in the eye region 50 detected in step S2. In the present embodiment, the eye gaze information detected in step S6 is assumed to include coordinate data indicating the position of the eye gaze point on the display device 300 and information for identifying the object 301 displayed at the position of the eye gaze point on the display device 300.

Next, the management information generation unit 126 generates eye gaze management information in which the eye gaze information detected in step S6 is associated with the personal information acquired in step S5 (step S7). The output unit 127 stores the eye gaze management information generated in step S7 into a management information table (an example of the management information) (step Sg). The management information table is a table that stores eye gaze management information regarding one or more persons 400 generated by the management information generation unit 126. The management information table is stored in a memory (not illustrated) included in the processor 120 or a storage device (not illustrated) such as a hard disk drive or a solid state drive included in the image processing device 100.

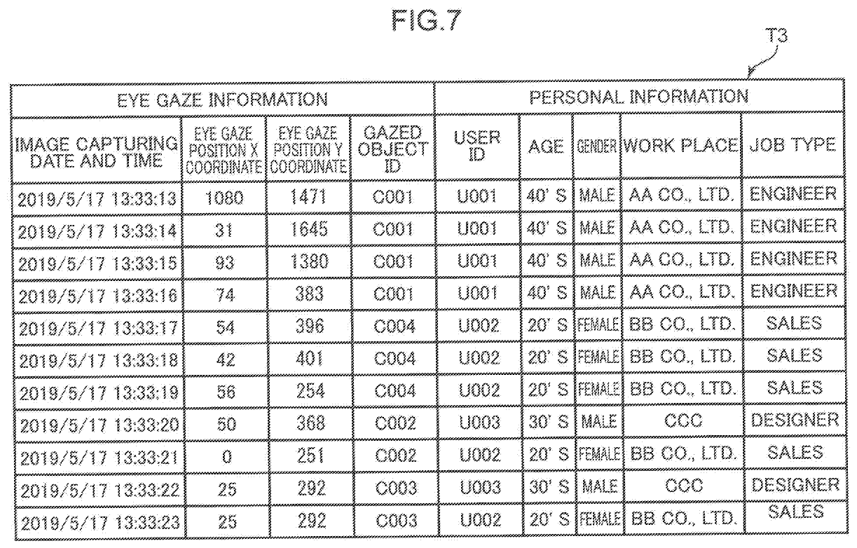

FIG. 7 is a view showing an example of a management information table T3. For example, in step S7, as shown in FIG. 7, the management information generation unit 126 generates eye gaze management information in which “image capturing date and time”, “eye gaze position X coordinate”, “eye gaze position Y coordinate”, and “gazed object ID” included in the eye gaze information detected in step S6 are associated with “user ID”, “age”, “gender”, “work place”, and “job type” included in the personal information acquired in step S5. The output unit 127 stores, in the management information table 13, the eye gaze management information generated by the management information generation unit 126.

The “image capturing date and time” is the acquisition date and time of the image data used to detect the eye gaze information, i.e., the date and time when the image data is acquired in step S1. The “eye gaze position X coordinate” is a horizontal component of the coordinate data indicating the position of the eye gaze point on the display device 300, and the “eye gaze position Y coordinate” is a vertical component of the coordinate data indicating the position of the eye gaze point. The “gazed object ID” is information for identifying the object 301 displayed at the position of the eye gaze point on the display device 300. The “age”, the “gender”, the “work place”, and the “job type” are information stored in advance as the attribute information in the user information table T2 (FIG. 5). Thus, in the present specific example, the eye gaze management information in which the “privacy information” included in the personal information is not associated with the eye gaze information but the “attribute information” included in the personal information is associated with the eye gaze information is generated. This makes it possible to generate the eye gaze management information with contents in which privacy is protected.

In the example of FIG. 7, in step S1, the image data of the face of the user whose “user ID” is “U001” when the date and time is “2019/5/17 13:33:13” is acquired. The eye gaze management information in which the eye gaze information whose “eye gaze position X coordinate” detected from the image data is “1080” is associated with the personal information whose “user ID” is “U001” is generated and stored in the management information table T3. In this manner, in the example of FIG. 7, the management information table T3 stores the eye gaze management information for a total of 11 persons 400 including the same person 400.

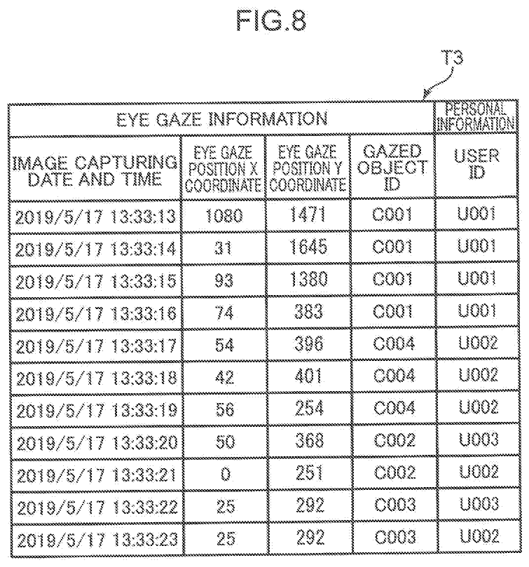

The eye gaze management information generated in step S7 is not limited to the above. FIG. 8 is a view showing another example of the management information table T3. For example, as shown in FIG. 8, the management information generation unit 126 may generate the eye gaze management information in which “image capturing date and time”, “eye gaze position X coordinate”, “eye gaze position Y coordinate”, and “gazed object ID” included in the eye gaze information detected in step S6 are associated with information (“user ID”) in which the “privacy information” (FIG. 5) and the “attribute information” (FIG. 5) are removed from the personal information acquired in step S5. Alternatively, step S4 may be omitted, and in step S7, the “user ID” of the user who has been subjected to the personal authentication in step S3 may be associated, as the personal information, with the eye gaze information detected in step S6.

In this manner, by removing the “privacy information” (FIG. 5) and the “attribute information” (FIG. 5) from the personal information to be associated with the eye gaze information, the time required for generation of eye gaze management information may be further shortened. In addition, after the generation of the eye gaze management information, step S4 may be performed using the “user ID” included in the eye gaze management information at an arbitrary timing. Then, the personal information acquired in step S4 may be added to the eye gaze management information including the “user ID” used in step S4. In this manner, the details of the personal information of the authenticated user may be added as the eye gaze management information afterwards.

Thus, when the information indicating the vector indicating the direction of the eye gaze of the person 400 is included in the eye gaze information as described above, the management information generation unit 126 may generate the eye gaze management information in which the information indicating the vector is associated with the personal information. In addition, the management information generation unit 126 may include an identifier for uniquely specifying the eye gaze management information in the generated eye gaze management information.

As described above, according to the present embodiment, for each of the one or more users of the image processing system 1, the detection of the eye gaze information and the personal authentication are performed based on the information indicating the eye of each user included in the image data including the eye of each user, and the personal information of each user is acquired. In the present embodiment, the eye gaze management information in which the thus acquired personal information and the eye gaze information are associated with each other is generated. In this manner, the result of generation of the eye gaze management information for one or more users is stored in the management information table T3.

Therefore, in the present embodiment, the image data used for generating the eye gaze management information in which the eye gaze information and the personal information of each user are associated with each other can be limited only to the image data including the eye of each user. Thus, in the present embodiment, the information in which the eye gaze information of each user is associated with the personal information of each user can be generated with a simpler configuration.

Furthermore, in the present embodiment, since the eye gaze information of each user and the image data used to acquire the personal information are the same, it is possible to detect the eye gaze information and perform the personal authentication based on the information indicating the eye of each user at the same time point. This enables the present configuration to acquire eye gaze information and personal information having no temporal difference regarding the user having been subjected to the personal authentication, and to generate the eye gaze management information in which the eye gaze information and the personal information are associated with each other.

Therefore, based on the information indicating the eye of each user at different time points from each other, the present configuration can generate information in which the eye gaze information and the personal information of each user are associated with each other with higher accuracy than in a case where the detection of the eye gaze information and the personal authentication are performed.

### Second Embodiment

In the second embodiment, the output unit 127 further generates eye gaze usage information in which the eye gaze information is classified for each of one or more attributes based on the eye gaze management information for one or more users generated by the management information generation unit 126, and outputs the eye gaze usage information.

For example, as shown in FIG. 7, it is assumed that the management information table T3 stores 11 pieces of eye gaze management information regarding users with the user IDs “U001”, “U002”, and “U003”. In this case, for example, the output unit 127 classifies the 11 pieces of eye gaze management information by “gender”, and generates, as the eye gaze usage information, six pieces of eye gaze management information with the “user ID” of “U001” and “U003”, in which “gender” is “male”. Then, the output unit 127 outputs the six pieces of eye gaze management information to the display device 300 as the eye gaze usage information together with the information indicating that the “gender” is “male”.

Similarly, the output unit 127 generates, as the eye gaze usage information, five pieces of eye gaze management information with the “user ID” of “U002” in which the “gender” is “female”, and displays, as the eye gaze usage information, the five pieces of eye gaze management information together with the information indicating that the “gender” is “female” in this case, the output unit 127 may display the information indicating that the “gender” is “female” in a color different from that of the information indicating that the “gender” is “male”, whereby make the display mode of the eye gaze usage information different according to the attribute corresponding to the eye gaze usage information of the display target. According to the present embodiment, the viewer of the eye gaze usage information can easily grasp the tendency of the eye gaze of the user having the same one or more attributes.

### Third Embodiment

In the third embodiment, in a case where, in the second embodiment, for example, as shown in FIG. 7, the coordinate data of the eye gaze point is included in the eye gaze information included in the eye gaze management information, the output unit 127 outputs, to the display device 300 as the eye gaze usage information, a heat map representing the relationship between the eye gaze point indicated by the coordinate data included in the eye gaze information and the frequency at which the eye gaze of the user is oriented to the eye gaze point.

Hereinafter, a method in which the output unit 127 outputs the above-described beat map to the display device 300 as the eye gaze usage information will be described with reference to FIG. 7. First, the output unit 127 classifies the 11 pieces of eye gaze management information shown in FIG. 7 by “gender”, generates six pieces of eye gaze management information with the “user ID” of “U001” and “U003” in which “gender” is “male” as the first eye gaze usage information, and generates five pieces of eye gaze management information with the “user ID” of “U002” in which “gender” is “female” as the second eye gaze usage information.

Next, for each of the first eye gaze usage information and the second eye gaze usage information, the output unit 127 refers to the eye gaze information in each piece of eye gaze management information included in each piece of eye gaze usage information, and calculates the frequency at which the eye gaze of the user is oriented to the eye gaze point (hereinafter, target eye gaze point) indicated by the coordinate data included in the referred eye gaze information.

Specifically, as the frequency at which the eye gaze of the user is oriented to the target eye gaze point, the output unit 127 calculates the frequency at which the eye gaze of the user is oriented to the object 301 (hereinafter, the target object) including the target eye gaze point.

For example, the first eye gaze usage information includes six pieces of eye gaze management information, where there are four pieces of eye gaze management information with the “gazed object ID” of “C001”, one piece of eye gaze management information with the “gazed object ID” of “C002”, and one piece of eye gaze management information with the “gazed object ID” of “C003”. In this case, the output unit 127 calculates, as “ 4/6”, the frequency at which the eye gaze of the user is oriented to the target object having the “gazed object ID” of “C001”. Then, the output unit 127 sets the calculated frequency “ 4/6” as a frequency at which the eye gaze of the user is oriented to each of the four target eye gaze points with the “image capturing date and time” of “2019/5/17 13:33:13” to “2019/5/17 13:33:16” included in the target object with the “gazed object ID” of “C001”.

Similarly, the output unit 127 calculates, as “⅙”, the frequency at which the eye gaze of the user is oriented to one target eye gaze point with the “image capturing date and time” of “2019/5/17 13:33:20” included in the target object with the “gazed object ID” of “C002”. In addition, the output unit 127 calculates, as “⅙”, the frequency at which the eye gaze of the user is oriented to one target eye gaze point with the “image capturing date and time” of “2019/5/17 13:33:22” included in the target object with the “gazed object ID” of “C003”.

Similarly, for the second eye gaze usage information, the output unit 127 calculates, as “⅗”, the frequency at which the eye gaze of the user is oriented to the three target eye gaze points with the “image capturing date and time” of “2019/5/17 13:33:17” to “2019/5/17 13:33:19” included in the target object with the “gazed object ID” of “C004”. In addition, the output unit 127 calculates, as “⅕”, the frequency at which the eye gaze of the user is oriented to one target eye gaze point with the “image capturing date and time” of “2019/5/17 13:33:21” included in the target object with the “gazed object ID” of “C002”. In addition, the output unit 127 calculates, as “⅕”, the frequency at which the eye gaze of the user is oriented to one target eye gaze point with the “image capturing date and time” of “2019/5/17 13:33:23” included in the target object with the “gazed object ID” of “C003”.

Next, the output unit 127 displays, on the display device 300, each target eye gaze point included in the first eye gaze usage information in a more highlighted manner as the frequency at which the eye gaze of the user is oriented to each target eye gaze point is higher.

For example, the output unit 127 displays four target eye gaze points whose “image capturing date and time” are “2019/5/17 13:33:13” to “2019/5/17 13:33:16” and whose frequency is “ 4/6” in a more highlighted manner than one target eye gaze point whose “image capturing date and time” is “2019/5/17 13:33:20” and whose frequency is “⅙” and one target eye gaze point whose “image capturing date and time” is “2019/5/17 13:33:22” and whose frequency is “⅙”.

Similarly, the output unit 127 displays, on the display device 300, each target eye gaze point included in the second eye gaze usage information in a more highlighted manner as the frequency at which the eye gaze of the user is oriented to each target eye gaze point is higher. For example, the output unit 127 displays three target eye gaze points whose “image capturing date and time” are “2019/5/17 13:33:17” to “2019/5/17 13:33:19” and whose frequency is “⅗” in a more highlighted manner than one target eye gaze point whose “image capturing date and time” is “2019/5/17 13:33:21” and whose frequency is “⅕” and one target eye gaze point whose “image capturing date and time” is “2019/5/17 13:33:23” and whose frequency is “⅕”.

According to the present configuration, the viewer of the display device 300 can easily grasp which position the frequency at which the eye gaze of the user having the same attribute is oriented to is high.

### Fourth Embodiment

In the fourth embodiment, in a case where, in the second embodiment, for example, as shown in FIG. 7, the coordinate data of the eye gaze point is included in the eye gaze information included in the eye gaze management information, the output unit 127 outputs, to the display device 300 as the eye gaze usage information, a gaze plot representing the relationship among the eye gaze point indicated by the coordinate data included in the eye gaze information, the number of times at which the eye gaze of the user is oriented to the eye gaze point, and the movement route of the eye gaze of the user to the eye gaze point.

Hereinafter, a method in which the output unit 127 outputs the above-described gaze plot to the display device 300 as eye gaze usage information will be described with reference to FIG. 7. First, similarly to the third embodiment, the output unit 127 classifies the 11 pieces of eye gaze management information shown in FIG. 7 by “gender”, generates six pieces of eye gaze management information in which “gender” is “male” as the first eye gaze usage information, and generates five pieces of eye gaze management information in which “gender” is “female” as the second eye gaze usage information.

Next, for each of the first eye gaze usage information and the second eye gaze usage information, the output unit 127 refers to the eye gaze information in each piece of eye gaze management information included in each piece of eye gaze usage information, and calculates the number of times the eye gaze of the user is oriented to the target eye gaze point indicated by the coordinate data included in the referred eye gaze information.

Specifically, the output unit 127 calculates, as the number of times the eye gaze of the user is oriented to the target eye gaze point, the number of times the eye gaze of the user is oriented to the target object including the target eye gaze point.

For example, the first eye gaze usage information includes six pieces of eye gaze management information, where there are four pieces of eye gaze management information with the “gazed object ID” of “C001”, one piece of eye gaze management information with the “gazed object ID” of “C002”, and one piece of eye gaze management information with the “gazed object ID” of “C003”. In this case, the output unit 127 calculates, as “4”, the number of times the eye gaze of the user is oriented to the target object having the “gazed object ID” of “COO”. Then, the output unit 127 sets the calculated number of times “4” as the number of times the eye gaze of the user is oriented to each of the four target eye gaze points with the “image capturing date and time” of “2019/5/17 13:33:13” to “2019/5/17 13:33:16” included in the target object with the “gazed object ID” of “C001”.

Similarly, the output unit 127 calculates, as “1”, the number of times the eye gaze of the user is oriented to one target eye gaze point with the “image capturing date and time” of “2019/5/17 13:33:20” included in the target object with the “gazed object ID” of “C002”. Furthermore, the output unit 127 calculates, as “1”, the number of times the eye gaze of the user is oriented to one target eye gaze point with the “image capturing date and time” of “2019/5/17 13:33:22” included in the target object with the “gazed object ID” of “C003”.

Similarly, for the second eye gaze usage information, the output unit 127 calculates, as “3”, the number of times the eye gaze of the user is oriented to the three target eye gaze points with the “image capturing date and time” of “2019/5/17 13:33:17” to “2019/5/17 13:33:19” included in the target object with the “gazed object ID” of “C004”. In addition, the output unit 127 calculates, as “1”, the number of times the eye gaze of the user is oriented to one target eye gaze point with the “image capturing date and time” of “2019/5/17 13:33:21” included in the target object with the “gazed object ID” of “C002”. In addition, the output unit 127 calculates, as “I”, the number of times the eye gaze of the user is oriented to one target eye gaze point with the “image capturing date and time” of “2019/5/17 13:33:23” included in the target object with the “gazed object ID” of “C003”.

Next, for each of the first eye gaze usage information and the second eye gaze usage information, the output unit 127 displays, on the display device 300, the number of times the eye gaze of the user has been oriented to each target eye gaze point in a region where the target object including each target eye gaze point included in each eye gaze usage information is displayed.

For example, on the display device 300, the output unit 127 displays “4”, which is the number of times the eye gaze of the user has been oriented to each of the four target eye gaze points, in the region where the target object with the “gazed object ID” of “C001” is displayed, including the four target eye gaze points with the “image capturing date and time” of “2019/5/17 13:33:13” to “2019/5/17 13:33:16” included in the first eye gaze usage information.

Similarly, on the display device 300, the output unit 127 displays “1”, which is the number of times the eye gaze of the user has been oriented to one target eye gaze point, in the region where the target object with the “gazed object ID” of “C002” is displayed, including the one target eye gaze point with the “image capturing date and time” of “2019/5/17 13:33:20” included in the first eye gaze usage information. In addition, on the display device 300, the output unit 127 displays “1”, which is the number of times the eye gaze of the user has been oriented to one target eye gaze point, in the region where the target object with the “gazed object ID” of “C003” is displayed, including the one target eye gaze point with the “image capturing date and time” of “2019/5/17 13:33:22” included in the first eye gaze usage information.

Similarly, on the display device 300, the output unit 127 displays “3”, which is the number of times the eye gaze of the user has been oriented to each of the three target eye gaze points, in the region where the target object with the “gazed object ID” of “C004” is displayed, including the three target eye gaze points with the “image capturing date and time” of “2019/5/17 13:33:17” to “2019/5/17 13:33:19” included in the second eye gaze usage information. In addition, on the display device 300, the output unit 127 displays “1”, which is the number of times the eye gaze of the user has been oriented to one target eye gaze point, in the region where the target object with the “gazed object ID” of “C002” is displayed, including the one target eye gaze point with the “image capturing date and time” of “2019/5/17 13:33:21” included in the second eye gaze usage information. In addition, on the display device 300, the output unit 127 displays “1”, which is the number of times the eye gaze of the user has been oriented to one target eye gaze point, in the region where the target object with the “gazed object ID” of “C003” is displayed, including the one target eye gaze point with the “image capturing date and time” of “2019/5/17 13:33:23” included in the second eye gaze usage information.

Next, for each of the first eye gaze usage information and the second eye gaze usage information, the output unit 127 refers to each target eye gaze point included in each eye gaze usage information in chronological order of “image capturing date and time” corresponding to each target eye gaze point. Then, the output unit 127 outputs a straight line connecting the currently referred target eye gaze point and the target eye gaze point to be referred to next to the display device 300 as a movement route of the eye gaze of the user to the target eye gaze point to be referred to next.

For example, the output unit 127 outputs, to the display device 300, a straight line connecting the target eye gaze point whose “image capturing date and time” is the oldest “2019/5/17 13:33:13” and the target eye gaze point whose “image capturing date and time” is the next oldest “2019/5/17 13:33:14” among the target eye gaze points included in the first eye gaze usage information. Similarly, the output unit 127 outputs, to the display device 300, a straight line connecting the target eye gaze point whose “image capturing date and time” is “2019/5/17 13:33:14” and the target eye gaze point whose “image capturing date and time” is the next oldest “2019/5/17 13:33:15” among the target eye gaze points included in the first eye gaze usage information. Thereafter, similarly, the output unit 127 outputs the straight line to the display device 300, and finally, outputs, to the display device 300, a straight line connecting the target eye gaze point whose “image capturing date and time” is the newest “2019/5/17 13:33:22” and the target eye gaze point whose “image capturing date and time” is the next newest “2019/5/17 13:33:20” among the target eye gaze points included in the first eye gaze usage information.

Similarly, the output unit 127 outputs, to the display device 300, a straight line connecting the target eye gaze point whose “image capturing date and time” is the oldest “2019/5/17 13:33:17” and the target eye gaze point whose “image capturing date and time” is the next oldest “2019/5/17 13:33:18” among the target eye gaze points included in the second eye gaze usage information. Thereafter, similarly, the output unit 127 outputs the straight line to the display device 300, and finally, outputs, to the display device 300, a straight line connecting the target eye gaze point whose “image capturing date and time” is the newest “2019/5/17 13:33:23” and the target eye gaze point whose “image capturing date and time” is the next newest “2019/5/17 13:33:21” among the target eye gaze points included in the second eye gaze usage information.

According to the present configuration, the viewer of the display device 300 can easily grasp which position on which movement route the eye gaze of the user having the same attribute is oriented to many times.

### Fifth Embodiment

When the number of users of the image processing system 1 becomes as large as, for example, several thousands, the number of records of the authentication information stored in the authentication information table T1 (FIG. 4) increases. In this case, the number of records referred to in the processing of the personal authentication using the iris information and the authentication information table T1 (FIG. 4) by the iris authentication unit 123 in step S3 (FIG. 6) increases, and the time required for the processing increases. As a result, start of the processing in and after step S4 (FIG. 6) is delayed, and there is a possibility that the eye gaze management information cannot be quickly generated.

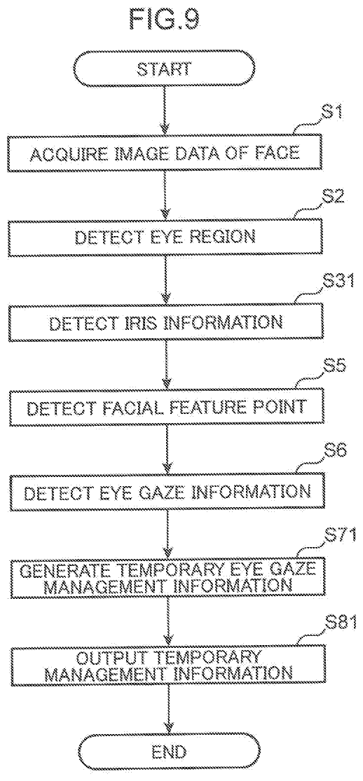

In the fifth embodiment, in order to avoid such a problem, the iris authentication unit 123 performs processing of the personal authentication of the person 400 using detected iris information and the authentication information storage unit 141, which is performed after the iris information is detected in step S3 (FIG. 6), at timing different from the processing for detecting the eye gaze information. Then, the management information generation unit 126 acquires the personal information of the person 400 who has been subjected to the personal authentication after the processing of the personal authentication, and generates the eye gaze management information in which the acquired personal information is associated with the eye gaze information detected at another timing. A method for generating eye gaze management information in the fifth embodiment will be described below with reference to FIGS. 9 to 11.

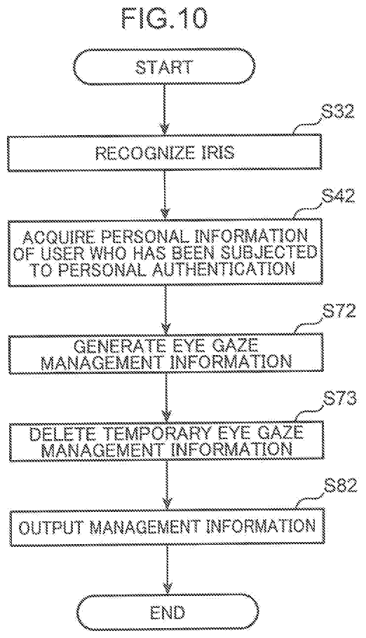

FIGS. 9 and 10 are flowcharts showing an example of the operation of image processing device 100 according to the fifth embodiment. Specifically, the operation of the image processing device 100 shown in FIG. 9 is started periodically (e.g., every second), similarly to the operation of the image processing device 100 shown in FIG. 6. When the operation of the image processing device 100 is started, steps S1 and S2 described above are performed.

Next, similarly to step S3 (FIG. 6), the iris authentication unit 123 detects iris information indicating the iris 56 of the eye of the person 400 from the eye region 50 detected in step S2 (step S31). After step S31, step S4 (FIG. 6) is omitted, and steps S5 and S6 are performed.

Next, the management information generation unit 126 generates temporary eye gaze management information in which the iris information detected in step S31 is associated with the eye gaze information detected in step S6 (step S71). The output unit 127 stores the temporary eye gaze management information generated in step S71 into a temporary management information table (step S81). The temporary management information table is a table that stores the temporary eye gaze management information regarding one or more persons 400 generated by the management information generation unit 126. The temporary management information table is stored in a memory (not illustrated) included in the processor 120 or a storage device (not illustrated) such as a hard disk drive or a solid state drive included in the image processing device 100.

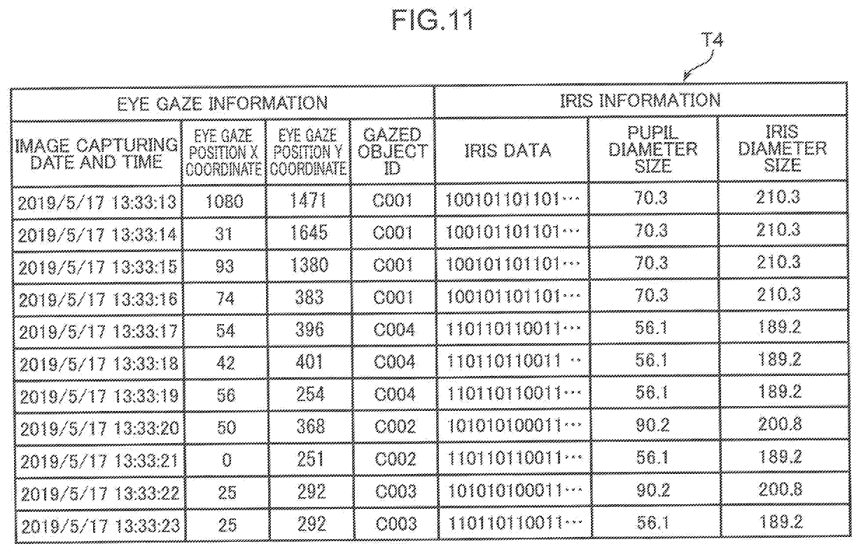

FIG. 11 is a view showing an example of a temporary management information table T4. For example, in step S71, as shown in FIG. 11, the temporary management information table T4 stores temporary eye gaze management information in which “image capturing date and time”. “eye gaze position X coordinate”, “eye gaze position Y coordinate”, and “gazed object ID” included in the eye gaze information detected in step S6 are associated with “iris data”, “pupil diameter size”, and “iris diameter size” included in the iris information detected in step S31. The “iris data” is iris data included in the iris information detected in step S31. The “pupil diameter size” is the length of the diameter of the outer edge of the pupil 55 included in the iris information detected in step S31. The “iris diameter size” is the length of the diameter of the outer edge of the iris 56 included in the iris information detected in step S31.

The operation of the image processing device 100 shown in FIG. 10 is started at an arbitrary timing when one or more pieces of temporary eye gaze management information items are stored in the temporary management information table T4. When the operation of the image processing device 100 shown in FIG. 10 is started, the iris authentication unit 123 refers to one piece of temporary eye gaze management information stored in the temporary management information table T4, and performs the personal authentication of the person 400 similarly to step S3 (FIG. 6) using the iris information included in the referred temporary eye gaze management information (step S32). Next, the management information generation unit 126 acquires the personal information of the person 400 who has been subjected to the personal authentication in step S32 similarly to step S4 (FIG. 6) (step S42).

Next, similarly to step S7 (FIG. 6), the management information generation unit 126 generates the eye gaze management information in which the eye gaze information included in one piece of temporary eye gaze management information referred to in step S32 is associated with the personal information acquired in step S42 (step S72). Next, the management information generation unit 126 deletes the one piece of temporary eye gaze management information referred to in step S32 from the temporary management information table T4 (step S73). Next, the output unit 127 stores, similarly to step Sg (FIG. 6), the eye gaze management information generated in step S72 into the management information table T3 (FIG. 7) (step S82).

According to the present configuration, the processing of personal authentication, which is likely to increase the processing time, can be performed at an arbitrary timing when one or more pieces of temporary eye gaze management information are stored in the temporary management information table T4. This makes it possible to eliminate a possibility that a large time difference occurs between the detection timing of eye gaze information used to generate eye gaze management information and the acquisition timing of the personal information associated with the eye gaze information. Thus, the eye gaze management information can be quickly generated.

It is assumed that a difference between the acquisition date and time of the personal information in step S42 and the “image capturing date and time” included in the eye gaze information associated with the personal information in step S72 is equal to or greater than a predetermined time. In this case, the acquired personal information is personal information stored in the user information table T2 (FIG. 5) at the time point when a time equal to or greater than the predetermined time has elapsed since the image data used to detect the eye gaze information was acquired. Therefore, there is a possibility that the personal information is different from the personal information of the user at the time point when the image data was acquired. Therefore, in a case where the difference between the acquisition date and time of the personal information in step S42 and the “image capturing date and time” included in the eye gaze information associated with the personal information in step S72 is equal to or greater than a predetermined time, the eye gaze management information may not be generated in step S72.

### Sixth Embodiment

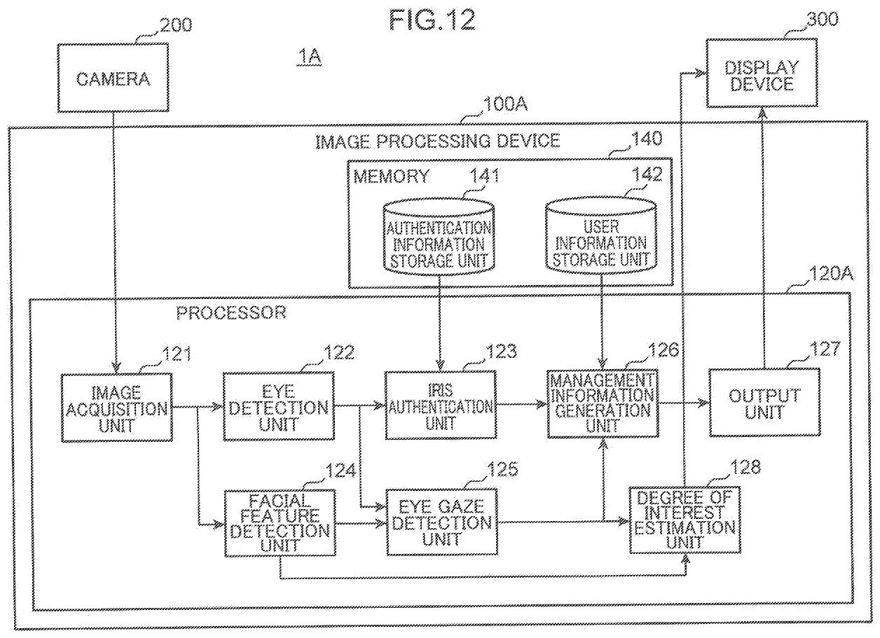

In the sixth embodiment, the degree of interest of the person 400 is estimated. FIG. 12 is a block diagram showing an example of a detailed configuration of the image processing system IA according to the sixth embodiment. In the present embodiment, identical components as those in the above-described embodiments are given identical reference numerals, and description thereof will be omitted. Furthermore, in FIG. 12, a block having an identical name as that in FIG. 2 but having a different function is given a reference sign A at the end.

A processor 120A further includes a degree of interest estimation unit 128.

The degree of interest estimation unit 128 estimates the degree of interest of the person 400 by the following processing. First, the degree of interest estimation unit 128 detects an eyebrow and a corner of the mouth from the face region using the facial feature point detected by the facial feature detection unit 124. Here, the degree of interest estimation unit 128 is only required to detect the eyebrow and the corner of the mouth by specifying the feature points to which the landmark point numbers respectively corresponding to the eyebrow and the corner of the mouth are imparted among the facial feature points detected by the facial feature detection unit 124.

Next, the degree of interest estimation unit 128 estimates the degree of interest of the person 400 based on the eye gaze information detected by the eye gaze detection unit 125 and the position of the eyebrow and the position of the corner of the mouth having been detected, and outputs the degree of interest to the display device 300. Specifically, the degree of interest estimation unit 128 acquires, from a memory (not illustrated) for example, pattern data in which standard positions of the eyebrow and the corner of the mouth when a person puts on various expressions such as joy, surprise, anger, sadness, and blankness are described in advance. Then, the degree of interest estimation unit 128 collates the detected positions of the eyebrow and the corner of the mouth of the person 400 with the pattern data, and estimates the expression of the person 400. Then, using the estimated expression of the person 400 and the eye gaze indicated by the eye gaze information, the degree of interest estimation unit 128 specifies as to what expression the person 400 makes when the eye gaze of the person 400 is in which direction or the eye gaze point of the person 400 is present in which position. That is, the degree of interest estimation unit 128 specifies, as the degree of interest of the person 400, data in which the eye gaze information and the expression of the person 400 are associated with each other. Note that, here, the degree of interest estimation unit 128 is described here to estimate the degree of interest based on the eyebrow and the corner of the mouth, but this is an example, and the degree of interest may be estimated based on one of the eyebrow and the corner of the mouth.

As described above, according to the present embodiment, since the degree of interest of the person 400 is estimated by further using the eyebrow and the corner of the mouth in addition to the eye gaze information, the degree of interest can be estimated with higher accuracy as compared with the degree of interest estimation based only on the eye gaze information.

(Modifications)

(1) In the above-described embodiment, the case where the operation of the image processing device 100 shown in FIGS. 6 and 9 is started periodically (e.g., every second) has been described. However, instead of this, the operation of the image processing device 100 shown in FIGS. 6 and 9 may be started every time the image data of the face of the person 400 is captured by the camera 200. Alternatively, the operation of the image processing device 100 shown in FIGS. 6 and 9 may be started the predetermined number of times every time the image data of the face of the person 400 is captured a predetermined number of times by the camera 200.

(2) If an infrared light camera is adopted as the camera 200, the infrared light camera is only required to be an infrared light camera using infrared light in a predetermined second wavelength band in which the spectral intensity of sunlight is attenuated more than a predetermined first wavelength. The predetermined first wavelength is, for example, 850 nm. The predetermined second wavelength is, for example, 940 nm. The second wavelength band does not include, for example, 850 nm and is a band having a predetermined width with 940 nm as a reference (e.g., the center). As an infrared light camera that captures near-infrared light, one that uses infrared light of 850 nm is known. However, since the spectral intensity of sunlight is not sufficiently attenuated at 850 nm, there is a possibility that highly accurate eye gaze information detection cannot be performed outdoors where the spectral intensity of sunlight is strong. Therefore, as an infrared light camera, the present disclosure employs a camera that uses infrared light in a band of 940 nm, for example. This makes it possible to perform highly accurate eye gaze information detection even outdoors where the spectral intensity of sunlight is strong. Here, the predetermined second wavelength is 940 nm, but this is an example, and may be a wavelength slightly shifted from 940 nm. Note that the infrared light camera using the infrared light of the second wavelength is, for example, a camera including a light projector that irradiates with the infrared light of the second wavelength.

(3) In the above embodiment, the eye gaze information is described to include the coordinate data indicating the eye gaze point, but the present disclosure is not limited thereto. For example, the eye gaze information may include coordinate data indicating an eye gaze plane that is a region having a predetermined shape (e.g., a circle, a quadrangle, or the like) with a predetermined size with the eye gaze point as a reference (e.g., the center). This makes it possible to appropriately determine the eye gaze target object without depending on the distance between the person 400 and the eye gaze target object or the size of the eye gaze target object.

(4) in the above-described embodiment, an example in which the image processing system 1 is applied to a digital signage system has been described, but the image processing system 1 is also applicable to, for example, an exhibition. In this case, assuming that the participant of the exhibition is a user of the image processing system 1, the work place of the participant is only required to be included in the attribute information of the user stored in the user information table T2. Furthermore, the eye gaze information is only required to include exhibit information indicating an exhibit of the exhibition existing at a position to which the eye gaze of each user is oriented. The exhibit information may include, for example, the name of the exhibit and/or the identifier of the exhibit. Then, similarly to the above-described third embodiment, the output unit 127 may display, on the display device 300, a heat map representing the relationship between the exhibit of the exhibition indicated by the exhibit information and the frequency at which the eye gaze of the user is oriented to the exhibit of the exhibition. In this case, the viewer of the heat map having been output can easily grasp, for example, in the exhibition, an eye gaze of a participant of which work place is highly frequently oriented to which exhibit.

In addition, the attribute information of the user stored in the user information table T2 may include the job type of the participant of the exhibition, and the processing similar to that of the above-described third embodiment may be performed. In this case, the viewer of the heat map output by the output unit 127 can easily grasp, in the exhibition, an eye gaze of a participant of which job type is highly frequently oriented to which exhibit.

Alternatively, the image processing system 1 can also be applied to, for example, a manufacturing site. In this case, assuming that the worker at the manufacturing site is a user of the image processing system 1, the work proficiency of the worker may be included in the attribute information of the user stored in the user information table T2. The eye gaze information is only required to include work target information indicating a work target present at a position to which the eye gaze of each user is oriented. The work target information may include, for example, a name of the work target and/or an identifier of the work target. Then, similarly to the third embodiment, the output unit 127 is only required to display, on the display device 300, the heat map representing the relationship between the work target indicated by the work target information and the frequency at which the eye gaze of the user is oriented to the work target. In this case, the viewer of the heat map having been output can easily grasp, for example, at the manufacturing site, which work target an eye gaze of a highly proficient worker is highly frequently oriented to.

### INDUSTRIAL APPLICABILITY

Since the present disclosure can accurately generate information in which personal information of a user is associated with information indicating an eye gaze of the user with a simple configuration, the present disclosure is useful in estimation of an interest target of a person using eye gaze information, state estimation of a person, a user interface using eye gaze, and the like.

1. An information processing method in an information processing device, the information processing method comprising:
for each of one or more users,
acquiring image data including an eye of each of the users;
detecting eye gaze information indicating an eye gaze of each of the users based on information indicating the eye of each of the users included in the image data;
performing personal authentication on each of the users based on information indicating the eye of each of the users included in the image data;
acquiring personal information for identifying each of the users for which the personal authentication has been performed;
generating management information in which the personal information of the one or more users and the eye gaze information of the one or more users are associated with each other; and
outputting the management information.

2. The information processing method according to claim 1, wherein
the personal information includes one or more attributes indicating a nature or a feature of each of the users, and
in output of the management information,
based on the management information, eye gaze usage information in which the eye gaze information is classified for each of the one or more attributes is further generated, and the eye gaze usage information is output.

3. The information processing method according to claim 2, wherein the one or more attributes includes one or more of an age, a gender, a work place, and a job type.

4. The information processing method according to claim 2, wherein
the eye gaze information includes eye gaze position information indicating a position to which an eye gaze of each of the users is oriented, and
the eye gaze usage information is a heat map representing a relationship between a position indicated by the eye gaze position information and a frequency at which the eye gaze of the user is oriented to a position indicated by the eye gaze position information.

5. The information processing method according to claim 2, wherein
the eye gaze information includes eye gaze position information indicating a position to which an eye gaze of each of the users is oriented, and
the eye gaze usage information is a gaze plot representing a relationship among the position indicated by the eye gaze position information, a number of times the eye gaze of the user is oriented to the position indicated by the eye gaze position information, and a movement route of the eye gaze of the user to the position indicated by the eye gaze position information.

6. The information processing method according to claim 1, wherein
in detection of the eye gaze information,
information indicating the eye of each of the users and information indicating the orientation of the face of each of the users are detected from the image data, and the eye gaze information is detected based on the detected information indicating the eye of each of the users and the detected information indicating the orientation of the face of each of the users.

7. The information processing method according to claim 1, wherein
in personal authentication of each of the users,
iris information indicating an iris of the eye of each of the users is detected from the image data, and each of the users is subjected to the personal authentication based on the detected iris information.

8. The information processing method according to claim 2, wherein
the one or more users are participants in an exhibition,
the one or more attributes include a work place of the participants,
the eye gaze information includes exhibit information indicating an exhibit of the exhibition existing at a position to which an eye gaze of each of the users is oriented, and
the eye gaze usage information is a heat map representing a relationship between an exhibit of the exhibition indicated by the exhibit information and a frequency at which the eye gaze of the user is oriented to the exhibit of the exhibition.

9. The information processing method according to claim 2, wherein
the one or more users are workers at a manufacturing site,
the one or more attributes include work proficiency of the workers,
the eye gaze information include work target information indicating a work target present at a position to which an eye gaze of each of the users is oriented, and
the eye gaze usage information is a heat map representing a relationship between the work target indicated by the work target information and a frequency at which the eye gaze of the user is oriented to the work target.

10. The information processing method according to claim 7, wherein the image data is captured by an infrared light camera.

11. An information processing device comprising:
an image acquisition unit that acquires, for each of one or more users, image data including an eye of each of the users;
an eye gaze detection unit that detects, for each of the one or more users, eye gaze information indicating an eye gaze of each of the users based on information indicating an eye of each of the users included in the image data;
an authentication unit that performs, for each of the one or more users, personal authentication on each of the users based on information indicating an eye of each of the users included in the image data;
a personal information acquisition unit that acquires, for each of the one or more users, personal information for identifying each of the users for which the personal authentication has been performed;
a management information generation unit that generates management information in which the personal information of the one or more users and the eye gaze information of the one or more users are associated with each other; and
an output unit that outputs the management information.

12. A non-transitory computer readable storage medium storing a control program of an information processing device, the control program causing a computer equipped with the information processing device to function as
an image acquisition unit that acquires, for each of one or more users, image data including an eye of each of the users,
an eye gaze detection unit that detects, for each of the one or more users, eye gaze information indicating an eye gaze of each of the users based on information indicating the eye of each of the users included in the image data,
an authentication unit that performs, for each of the one or more users, personal authentication on each of the users based on information indicating the eye of each of the users included in the image data,
a personal information acquisition unit that acquires, for each of the one or more users, personal information for identifying each of the users for which the personal authentication has been performed,
a management information generation unit that generates management information in which the personal information of the one or more users and the eye gaze information of the one or more users are associated with each other, and
an output unit that outputs the management information.
